(19) United States
(12) Patent Application Publication
(10) Pub. No.: US 2008/0297486 A1
(43) Pub. Date: Dec. 4, 2008

(54) COMMUNICATION TERMINAL HAVING TOUCH PANEL AND METHOD FOR DETERMINING TOUCH COORDINATE THEREIN

(75) Inventors: Yong Su KIM, Gumi-si (KR); Jae Gon SON, Daegu Metropolitan City (KR); Kang Wook KIM, Daegu Metropolitan City (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/122,859

(22) Filed: May 19, 2008

(30) Foreign Application Priority Data
Jun. 1, 2007 (KR) 2007-53675

(51) Int. Cl. G06F 3/041

(52) U.S. Cl. 345/173

(57) ABSTRACT

A communication terminal having a touch panel and a method for determining a touch coordinate therein are provided. The method includes setting one of a plurality of temporary coordinates of a touch position as a touch coordinate when a touch occurs on the touch panel, extracting a temporary coordinate at a position closest to the set touch coordinate from a plurality of temporary coordinates in a touch region on a drag path when a drag occurs from the touch position and updating the set touch coordinate using the extracted temporary coordinate. Accordingly, an unintentional change of the screen can be prevented on the touch panel of the communication terminal by preventing the communication terminal from too sensitively reacting to a minimal touch occurring on the touch pad.

### PRIORITY

This application claims the benefit under 35 U.S.C. §119(a) of a Korean patent application filed in the Korean Intellectual Property Office on Jun. 1, 2007 and assigned Serial No. 2007-0053675, the entire disclosure of which is hereby incorporated by reference.

### BACKGROUND OF THE INVENTION

1. Field of the Invention

The present invention relates generally to a communication terminal having a touch panel and a method for determining a touch coordinate therein. More particularly, the present invention relates to a communication terminal having a touch panel and a method for determining a touch coordinate on a drag path when a touch or a drag occurs on the touch panel.

2. Description of the Related Art

In general, a communication terminal processes text and graphics by using various input units such as a keyboard, a mouse, a digitizer and the like. More recently, touch panels are being widely used as an input unit for communication terminals. A touch panel can assist in the miniaturization of communication terminals because of its simple manipulation, its small error rate, and no requirement for an additional input unit because the touch panel can function as both a display unit and an input unit. When a touch or a drag occurs on the touch panel, the communication terminal determines a touch coordinate in correspondence to a touch position. In addition, the communication terminal controls its state according to the touch coordinate or a change in the touch coordinate.

However, the communication terminal independently determines each touch coordinate in correspondence to each touch position when a touch or a drag occurs on the touch panel. Accordingly, the communication terminal reacts in an overly sensitive manner and associates even a minimal movement occurring on the touch panel as a drag. That is, the communication terminal may recognize an unintended shake or slight movement of a finger or a stylus on a touch panel as a drag. As a result, the state of the communication terminal may be unintentionally changed, thus causing the user an inconvenience in viewing the screen.

### SUMMARY OF THE INVENTION

An aspect of the present invention is to address the above-mentioned problems and/or disadvantages and to provide at least the advantages described below. Accordingly, an aspect of the present invention is to provide a communication terminal having a touch panel and a method for determining a touch coordinate therein capable of determining the touch coordinate on a drag path by using a touch coordinate of a previous touch position when a touch or a drag occurs on the touch panel.

In accordance with an aspect of the present invention, a method for determining a touch coordinate in a communication terminal having a touch panel is provided. The method includes setting one of a plurality of temporary coordinates of a touch position as a touch coordinate when a touch occurs on the touch panel, extracting a temporary coordinate at a position closest to the set touch coordinate from a plurality of temporary coordinates in a touch region on a drag path when a drag occurs from the touch position and updating the set touch coordinate using the extracted temporary coordinate.

In accordance with another aspect of the present invention, a communication terminal having a display unit displaying a current state is provided. The communication terminal includes a touch panel coupled to the display unit to detect an occurrence of at least one of a touch, a drag and a drop, a coordinate determining unit for setting one of a plurality of temporary coordinates of a touch position as a touch coordinate when a touch occurs, for detecting a plurality of temporary coordinates in a touch region on a drag path when a drag occurs from the touch position, for calculating coordinate changes from the set touch coordinate to each of the plurality of detected temporary coordinates, for extracting a temporary coordinate having the smallest coordinate change, and for updating the set touch coordinate using the extracted temporary coordinate and a touch coordinate memory for storing the set touch coordinate under the control of the coordinate determining unit.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a block diagram schematically illustrating a communication terminal according to an exemplary embodiment of the present invention;

FIG. 2 is a flowchart for explaining a procedure of determining a touch coordinate according to an exemplary embodiment of the present invention;

FIG. 3 is a flowchart for explaining an exemplary procedure of setting a touch coordinate in FIG. 2; and

FIG. 4 is a flowchart for explaining an exemplary procedure of changing a touch coordinate in FIG. 2.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

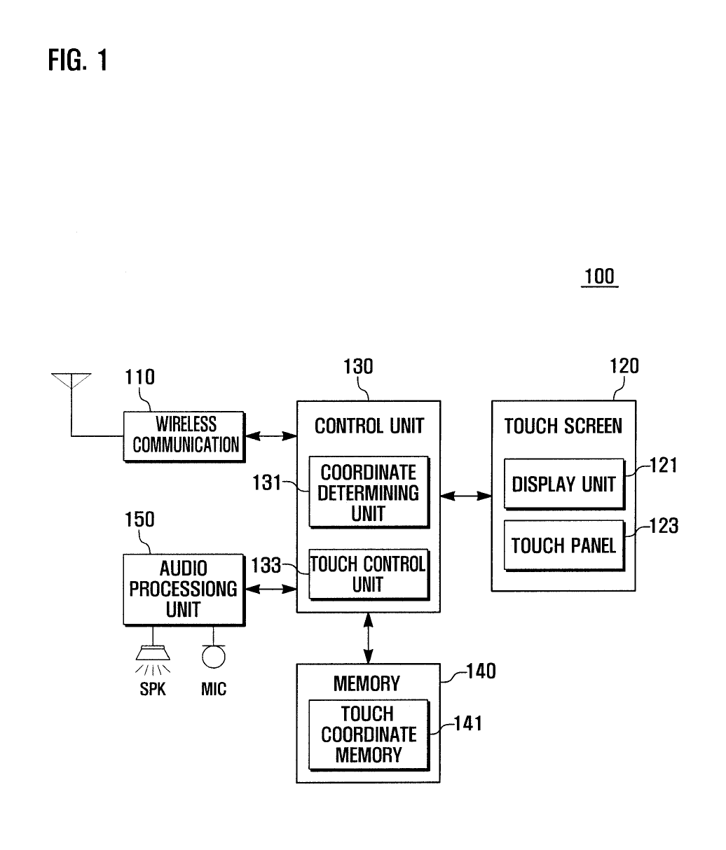

FIG. 1 is a block diagram schematically illustrating a communication terminal according to an exemplary embodiment of the present invention. For ease of description, the communication terminal in the exemplary embodiment of FIG. 1 is illustrated as a mobile phone. However, it is to be understood that this is merely an example and in no way limiting of the invention.

Referring to FIG. 1, the communication terminal 100 includes a wireless communication unit 110, a touch screen 120, a control unit 130, a memory 140, and an audio processing unit 150.

The wireless communication unit 110 performs a wireless communication function of the communication terminal 100. The wireless communication unit 110 includes an RF transmitter for raising the frequency and amplifying the signal to be transmitted and an RF receiver for low noise-amplifying a received signal and for lowering the frequency of the signal.

The touch screen 120 includes a display unit 121 and a touch panel 123. The display unit 121 displays the state of the communication terminal 100. In an exemplary implementation, the display unit 121 is realized with an LCD, and includes an LCD control unit, a memory capable of storing display data, an LCD display device, etc. The touch panel 123 is mounted to or otherwise integral with the display unit 121 and includes a touch detection unit and a signal conversion unit. The touch detection unit detects the occurrence of a touch, a drag, a drop, etc. from a change in magnitude of a physical parameter such as pressure or other force or a change in magnitude of an electrical parameter such as capacitance or resistance. The signal conversion unit converts the change in the magnitude of the physical or electrical parameter into a touch signal.

The control unit 130 performs a function of controlling the overall operation of the communication terminal 100. The control unit 130 includes a data processing unit having a transmitter for encoding and modulating a signal to be transmitted and a receiver for demodulating and decoding a received signal. The data processing unit may also include a modem and a codec. Furthermore, the control unit 130 includes a coordinate determining unit 131 and a touch control unit 133 according to an exemplary embodiment of the present invention.

The coordinate determining unit 131 sets a touch coordinate of a touch position on a touch panel 123 when a touch occurs. More specifically, after the coordinate determining unit 131 detects a plurality of temporary coordinates in a touch region of the touch position, it calculates an arithmetic mean of the plurality of temporary coordinates. The coordinate determining unit 131 stores the calculated arithmetic mean as the touch coordinate. Further, when a drag occurs from the touch position, the coordinate determining unit 131 extracts a temporary coordinate closest to the touch coordinate from a plurality of temporary coordinates in a touch region on a drag path. That is, after the coordinate determining unit 131 detects a plurality of temporary coordinates in a touch region, it calculates coordinate changes from the stored touch coordinate to each of the detected temporary coordinates, respectively. In addition, the coordinate determining unit 131 updates the touch coordinate with the extracted temporary coordinate. Then, the coordinate determining unit 131 initializes or resets the stored touch coordinate when a drop occurs from the touch position from which the touch coordinate is set or the touch position on the drag path.

The touch control unit 133 controls the state displayed on the display unit 121 in correspondence with the update of the touch coordinate determined by the coordinate determining unit 131. That is, the touch control unit 133 can control the state displayed on the display unit 121 when a drag occurs from the touch position. On the other hand, the touch control unit 133 can control the state displayed on the display unit 121 when a drop occurs from the touch position from which the touch coordinate is set or the touch position on the drag path.

The memory 140 includes a program memory and a data memory. The program memory stores an operation program of the communication terminal 100. The program memory also stores a program for determining the touch coordinate of the touch position occurring on the touch panel 123 and the touch coordinate of the touch position on the drag path. The data memory stores data generated during performance of a program. The memory 140 further includes a touch coordinate memory 141 for storing the touch coordinate being set and updated under the control of the coordinate calculating unit 131.

The audio processing unit 150 reproduces and generates a received audio signal output from an audio codec of the data processing unit through a speaker SPK or transmits a transmitted audio signal generated from a microphone MIC to the audio codec of the data processing unit.

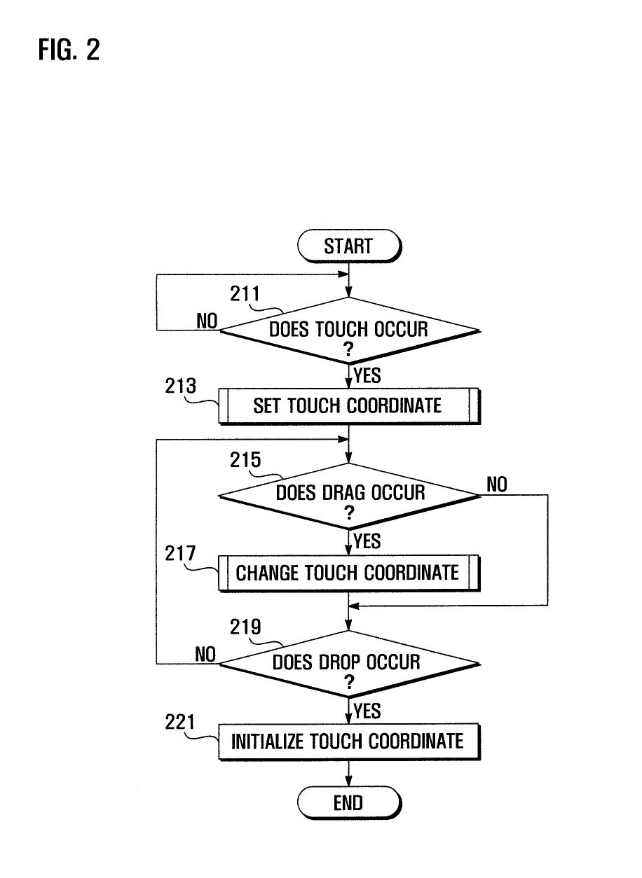

FIG. 2 is a flowchart for explaining a procedure of determining a touch coordinate according to an exemplary embodiment of the present invention.

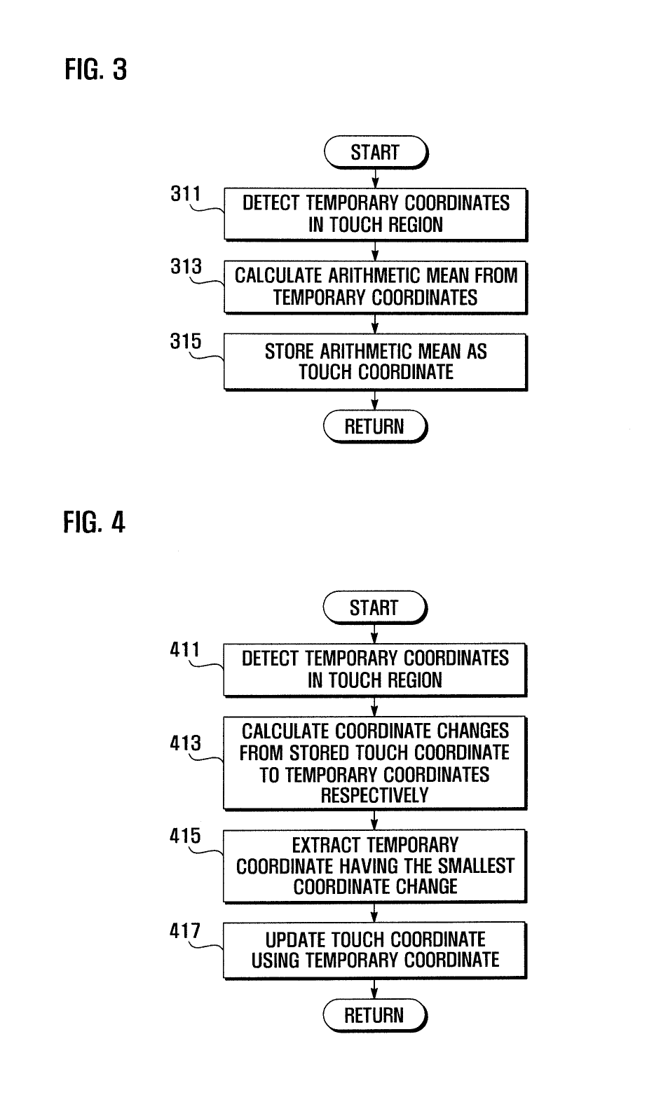

Referring to FIG. 2, a procedure of determining a touch coordinate according to an exemplary embodiment of the present invention includes detecting the occurrence of a touch through the touch panel 123 by the control unit 130 in step 211. If occurrence of a touch is detected, the control unit 130 performs a procedure of setting the touch coordinate in step 213. That is, the control unit 130 performs a procedure of setting the touch coordinate of the touch position occurring on the touch panel 123 and setting it as the initial touch coordinate. An exemplary procedure of setting a touch coordinate by the control unit 130 will be described in detail with reference to FIG. 3.

FIG. 3 is a flowchart for explaining an exemplary procedure for setting a touch coordinate in FIG. 2.

Referring to FIG. 3, the control unit 130 detects a plurality of temporary coordinates in a touch region in step 311. More specifically, the control unit 130 detects changes in the magnitudes of physical or electrical parameters of the upper, lower, right and left locations of each of a plurality of touch positions pertaining to the touch region and digitally converts them. Using the digitally converted values, the control unit 130 detects the temporary coordinates of the corresponding touch position. The control unit 130 excludes temporary coordinates that are out of an error range from the detected temporary coordinates.

Then, the control unit 130 calculates an arithmetic mean from the plurality of temporary coordinates in step 313. After the control unit 130 stores the calculated arithmetic mean in the touch coordinate memory 141 in step 315, the procedure is returned to FIG. 2. Then, the control unit 130 sets the arithmetic mean stored in the touch coordinate memory 141 as the touch coordinate.

Thereafter, if a drag occurs from the corresponding touch position with the touch coordinate being set, the control unit 130 detects it in step 215, and performs a procedure of changing the touch coordinate in step 217. More specifically, the control unit 130 determines the touch coordinate of the touch position on a drag path and updates the setting of the touch coordinate using the newly determined touch coordinate. An exemplary procedure of changing the touch coordinate by the control unit 130 will be described in detail with reference to FIG. 4.

FIG. 4 is a flowchart for explaining an exemplary procedure of changing the touch coordinate.

Referring to FIG. 4, the control unit 130 detects a plurality of temporary coordinates in a touch region on the drag path in step 411. That is, the control unit 130 detects changes in the magnitudes of the physical or electrical parameters of the upper, lower, right and left locations of each of a plurality of touch positions pertaining to the touch region on the drag path and digitally converts them. The control unit 130 detects the temporary coordinates of the corresponding touch position on the drag path from the ratio of the digitally converted values. The control unit 130 excludes temporary coordinates that are out of an error range from the detected temporary coordinates.

In step 413, the control unit 130 calculates respective coordinate changes between the touch coordinate stored in the touch coordinate memory 141 and the temporary coordinates detected in step 411. The control unit 130 calculates the coordinate changes by calculating absolute values of the differences between the touch coordinate and the temporary coordinates. The control unit 130 extracts a temporary coordinate having the smallest coordinate change by comparing the calculated coordinate changes in step 415. After the temporary coordinate having the smallest coordinate change is extracted, the control unit 130 stores the extracted temporary coordinate in place of the touch coordinate stored in the touch coordinate memory 141 in step 417 and the procedure is returned to FIG. 2. That is, the control unit 130 renews or updates the touch coordinate stored in the touch coordinate memory 141 by using the extracted temporary coordinate. Accordingly, when the drag of the touch occurring on the touch panel 123 is minimal, the touch coordinate stored in the touch coordinate memory 141 may be the same as the extracted temporary coordinate.

In step 219, the control unit 130 determines if a drop occurs from the corresponding touch position on the drag path after the touch coordinate has been updated. Then, the control unit 130 initializes the touch coordinate in step 221, and finishes the procedure of determining the touch coordinate. That is, in step 221, the control unit 130 changes or resets the touch coordinate stored in the touch coordinate memory 141 to an initial value, e.g. zero.

The control unit 130 controls the state displayed on the display unit 121 in correspondence with the renewal or update of the touch coordinate. That is, the control unit 130 can control the state displayed on the display unit 121 when a drag occurs from the touch position. On the other hand, the touch control unit 133 can control the state displayed on the display unit 121 when a drop occurs from the touch position from which the touch coordinate is set or the touch position on the drag path.

Meanwhile, if drags continuously occur with the touch coordinate being updated instead of a drop occurring from the corresponding touch position on the drag path, the control unit 130 repeats the above-mentioned processes of steps 215 to 219 until a drop occurs.

Furthermore, if a drop occurs from the touch position corresponding to the touch coordinate which was set in step 213 instead of a drag occurring from the corresponding touch position, the control unit 130 detects it in step 219, initializes the touch coordinate in step 221, and finishes the procedure of determining the touch coordinate. That is, the control unit 130 changes or resets the touch coordinate stored in the touch coordinate memory 141 to an initial value, e.g. zero.

As mentioned above, a communication terminal having a touch panel and a method of determining a touch coordinate therein according to exemplary embodiments of the present invention determine a touch coordinate on a drag path by using a touch coordinate of a previous touch position when a touch or a drag occurs on the touch panel. Accordingly, the communication terminal can be prevented from reacting in an overly sensitive manner from assuming that a minimal touch occurring on a touch pad is a drag motion. As a result, unintentional changes can be prevented on the touch panel of the communication terminal.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims and their equivalents.

What is claimed is:

1. A method for determining a touch coordinate in a communication terminal having a touch panel, the method comprising:
setting one of plurality of temporary coordinates of a touch position as a touch coordinate when a touch occurs on the touch panel;
extracting a temporary coordinate at a position closest to the set touch coordinate from a plurality of temporary coordinates in a touch region on a drag path when a drag occurs from the touch position; and
updating the set touch coordinate using the extracted temporary coordinate.

2. The method of claim 1, wherein the extracting of the temporary coordinate comprises:
detecting the plurality of temporary coordinates in the touch region;
calculating coordinate changes from the set touch coordinate to each of the plurality of detected temporary coordinates; and
extracting the temporary coordinate having the smallest coordinate change.

3. The method of claim 2, wherein the detecting of the plurality of temporary coordinates comprises detecting a change in magnitude of at least one of a physical and an electrical parameter for at least one of an upper, a lower, a right and a left location of each of the plurality of temporary coordinates.

4. The method of claim 1, wherein the extracting of the temporary coordinate and the updating of the set touch coordinate are repeated a plurality of times corresponding to each of a plurality of drags.

5. The method of claim 1, further comprising:
initializing the set touch coordinate when a drop of a touch occurs in the drag path.

6. The method of claim 1, further comprising:
initializing the set touch coordinate when a drop of a touch occurs from the touch position.

7. The method of claim 1, wherein the setting of the touch coordinate comprises:
detecting the plurality of temporary coordinates in a touch region of the touch position;
calculating an arithmetic mean of the plurality of temporary coordinates; and
storing the calculated arithmetic mean as the touch coordinate.

8. The method of claim 7, wherein the detecting of the plurality of temporary coordinates comprises detecting a change in magnitude of at least one of a physical and an electrical parameter for at least one of an upper, a lower, a right and a left location of each of the plurality of temporary coordinates.

9. A communication terminal having a display unit displaying a current state, the communication terminal comprising:
a touch panel coupled to the display unit to detect an occurrence of at least one of a touch, a drag and a drop;
a coordinate determining unit for setting one of a plurality of temporary coordinates of a touch position as a touch coordinate when a touch occurs, for detecting a plurality of temporary coordinates in a touch region on a drag path when a drag occurs from the touch position, for calculating coordinate changes from the set touch coordinate to each of the plurality of detected temporary coordinates, for extracting a temporary coordinate having the smallest coordinate change, and updating the set touch coordinate using the extracted temporary coordinate; and
a touch coordinate memory for storing the set touch coordinate under the control of the coordinate determining unit.

10. The communication terminal of claim 9, wherein the coordinate determining unit initializes the set touch coordinate of the touch coordinate memory when a drop occurs from at least one of the touch position and the touch region on the drag path.

11. The communication terminal of claim 9, wherein the coordinate determining unit detects the plurality of temporary coordinates in a touch region of the touch position when a touch occurs, calculates an arithmetic mean of the plurality of temporary coordinates, and sets the touch coordinate by storing the calculated arithmetic mean in the touch coordinate memory.

12. The communication terminal of claim 9, further comprising:
a touch control unit for controlling a state displayed on the display unit in correspondence to updating of the set touch coordinate.

13. The communication terminal of claim 12, wherein the touch control unit controls a state displayed on the display unit when a drag occurs from the touch position.

14. The communication terminal of claim 12, wherein the touch control unit controls a state displayed on the display unit when a drop occurs from at least one of the touch position and the touch region on the drag path.
